(19) United States
(12) Patent Application Publication
(10) Pub. No.: US 2009/0005531 A1
(43) Pub. Date: Jan. 1, 2009

(54) Solid state polymerization process for polyester

(76) Inventors: Thomas F. Thomspon, Highland Mills, NY (US); Stephen M. Andrews, New Fairfield, CT (US); Paul A. Odorisio, Leonia, NJ (US)

Correspondence Address: JoAnn Villamizar;Ciba Corporation/Patent Department, 540 White Plains Road, P.O. Box 2005, Tarrytown, NY, 10591, US

(21) Appl. No.: 12/215,277

(22) Filed: Jun. 26, 2008

Related U.S. Application Data
(60) Provisional application No. 60/937,509, filed on Jun. 28, 2007.

(51) Int. Cl. C08G 63/02

(52) U.S. Cl. 528/279

(57) ABSTRACT

Disclosed is a method for increasing the solid state polymerization (SSP) rates of organic titanate catalyzed polyester. The method comprises in a first step, reacting a dicarboxylic acid or a C₁-C₄ dicarboxylic diester with a diol at a suitable temperature and pressure to effect esterification or transesterification to prepare a precondensate and in a second step, reacting the precondensate to effect polycondensation at a suitable temperature and pressure to prepare a high molecular weight polyester and in a third step, further increasing the molecular weight and viscosity of the polyester under SSP conditions of a suitable temperature and pressure, where an organic titanate is added in the first step or in the second step as a reaction catalyst, and where a phosphinic acid compound is added in the first step, in the second step or just prior to the third step. The phosphinic acid compound is for example diisooctyl phosphinic acid. The polyester product exhibits low aldehyde formation during melt processing steps as well as excellent color.

This application claims benefit of U.S. provisional application No. 60/937,509, filed Jun. 28, 2007, the contents of which are incorporated by reference.

The invention relates to a method for the solid state polymerization (SSP) of polyesters, in particular polyethylene terephthalate, which method comprises employing certain phosphinic acid compounds in titanate catalyzed polyesters.

### BACKGROUND

Polyesters, such as polyethylene terephthalate (PET) are prepared industrially in a two stage process. The first stage in PET preparation involves the direct esterification of terephthalic acid with ethylene glycol, or alternatively transesterification of a C₁-C₄ dialkylterephthalate with ethylene glycol to form a low molecular weight precondensate. In a second stage, the precondensate is polycondensed to form high molecular weight polyethylene terephalate. Both stages typically employ catalytic acceleration.

Depending on the end use of the polyester, a further solid state polymerization step (SSP) is employed to arrive at the desired viscosity or molecular weight build up. The polyesters according to this invention are subjected to solid state polymerization.

Numerous compounds have been proposed as esterification, transesterification or polycondensation catalysts. Choice of catalyst effects the color, strength and processing properties of the end product. Choice of catalyst effects for example the amount of aldehyde generation. Choice of catalyst also controls selectivity of the reaction and effects the amount of impurities formed such as diethylene glycol, cyclic oligomers and carboxylic acid end groups.

Choice of catalyst also effects the time required to achieve a desired viscosity or molecular weight build up in the solid state polymerization step. Titanate catalyzed polyesters are known to exhibit relatively slow SSP rates as compared to for example antimony catalyzed polyesters. Nonetheless, titanate catalysts are valued by the polyester industry since they can provide for fast polycondensation rates at low levels. The value of titanate catalysts in the industry would be enhanced if their shortcoming in the SSP step could be overcome.

JP2002293909 is aimed at a method for producing polyester.

U.S. Pat. No. 7,205,379 discloses a process for the preparation of a stabilized polyester that is low in the generation of aldehydes.

U.S. Pat. No. 5,981,690 teaches poly(alkylene arylates) which are prepared using an organic titanate-ligand catalyst solution containing organic silicates and/or zirconates and, preferably, certain phosphorus compounds.

U.S. Pat. No. 5,453,479 is aimed at novel polyesterification catalysts comprising a phosphorus component and a titanium component which are useful in preparing improved blends of polyester and polycarbonate resins.

GB 1338091 is aimed at the production of highly polymeric polyesters of aromatic dicarboxylic acids and dihydric alcohols.

U.S. Pat. No. 6,013,756 teaches a process for producing polyesters using titanium-containing catalyst-inhibitor combinations.

U.S. published app. No. 2005/0239929 teaches a polyester that can be produced substantially without using an antimony compound as a polycondensation catalyst.

U.S. published app. No. 2007/0066791 discloses adding phosphorus compounds as catalyst deactivators to aluminum catalyzed polyester.

It has now been found that where titanate catalysts are employed in the esterification or transesterification or polycondensation steps of preparing a polyester, that the presence of certain phosphinate compounds provides for higher molecular weight build up, or viscosity increase, during a subsequent SSP step. That is, the SSP rate is increased. The high viscosity polyester obtained also has high brightness and low yellow color and exhibits little aldehyde formation on melt processing.

### SUMMARY

Disclosed is a method for the preparation of a polyester, which method comprises

in a first step, reacting a dicarboxylic acid or a C₁-C₄ dicarboxylic diester with a diol at a suitable temperature and pressure to effect esterification or transesterification to prepare a precondensate and

in a second step, reacting the precondensate to effect polycondensation at a suitable temperature and pressure to prepare a high molecular weight polyester and

in a third step, further increasing the molecular weight and viscosity of the polyester under solid state polymerization conditions of a suitable temperature and pressure,

where an organic titanate catalyst is added at one or more points
prior to, at the start of or during the first step or
prior to, at the start of or during the second step and

where a phosphinic acid compound is added at one or more points
prior to, at the start of or during the first step,
prior to, at the start of or during the second step or
towards the end of the second step.

### DETAILED DESCRIPTION

The dicarboxylic acid is selected from the group consisting of aromatic dicarboxylic acids having 8 to 14 carbon atoms, aliphatic dicarboxylic acids having 4 to 12 carbon atoms, cycloaliphatic dicarboxylic acids having 8 to 12 carbon atoms, and mixtures thereof.

The C₁-C₄ dicarboxylic diesters are dialkyl diesters of the above-mentioned dicarboxylic acids. The diesters are for instance dimethyl diesters.

Preferably such diacids are terephthalic acid, isophthalic acid, o-phthalic acid, naphthalene dicarboxylic acid, cyclohexane dicarboxylic acid, cyclohecanediacetic acid, diphenyl-4-4′-dicarboxylic acid, succinic acid, maleic acid, glutaric acid, adipic acid, sebacic acid or mixtures thereof.

Especially preferred acids and esters are terephthalic acid, dimethyl terephthalate, isophthalic acid and 2,6-naphthalene dicarboxylic acid.

The diols or glycols are derived from the generic formula HO—R—OH where R is an aliphatic, cycloaliphatic or aromatic moiety of 2 to 18 carbon atoms.

Such diols are for example ethylene glycol, diethylene glycol, triethylene glycol, propane-1,3-diol, propane-1,2-diol, butane-1,4-diol, pentane-1,5-diol, hexane-1,6-diol, 1,4-cyclohexanedimethanol, 3-methylpentane-2,4-diol, 2-methylpentane-1,4-diol, 2,2-diethylpropane-1,3-diol, 1,4-di(hydroxyethoxy)benzene, 2,2-bis(4-hydroxycyclohexyl)-propane, 2,4-dihydroxy-1,1,3,3-tetramethylcyclobutane, 2,2-bis-(3-hydroxyethoxyphenyl)propane, 2,2-bis-(4-hydroxypropoxyphenyl)ethane or mixtures thereof.

Preferably, the diol is ethylene glycol, 1,4-cyclohexanedimethanol or butane-1,4-diol.

The polyester is preferably poly(ethylene terephthalate ) PET or poly(ethylene-2,6-naphthalene-2,6-dicarboxylate) or poly(1,4-butylene terephthalate); most preferably poly(ethylene terephthalate).

The polyesters are prepared by methods well known in the art. Such methods are disclosed for example in U.S. published app. Nos. 2003083191 and 2004058805 and in the U.S. Pat. Nos. 5,744,571, 6,013,756, 5,453,479 and 7,205,379. These disclosures are incorporated herein by reference.

The first esterification or transesterification step is performed by mixing together one or more dicarboxylic acids or dicarboxylic diesters with one or more diols at temperatures in the range of about 150 to about 300° C., for example from about 200 to about 300° C., from about 260 to about 300° C., and at pressures of from up to 60 psig to atmospheric to about 0.2 mm Hg. The product of this step is a low molecular weight precondensate.

In the second step, polycondensation is effected by increasing the temperature and lowering the pressure while excess diol is removed. The temperature is for example from about 250 to about 300° C., for example from about 275 to about 300° C. The pressure is reduced to from about 10 to about 0.1 torr, or from about 5 to about 0.5 torr. The product is a high molecular weight polyester. The polyester has for example an IV of from about 0.55 to about 0.65 dL/g.

When the polycondenstation (polymerization) process of step 2 is completed, the resulting polyester, which is in the form of a melt, is generally filtered and is typically extruded and pelletized.

For example, the polyester melt may be extruded into polyester filaments, pellets, chips or other articles (primary extrusion step). Preferably, the polyester melt is extruded shortly or immediately after exiting the polycondensation step, whereupon it is quenched, for example in a water trough or alternative cooling unit. The formation of pellets or chips is particularly convenient for storage, transport and handling purposes.

In the third solid state polymerization (SSP) step, the high molecular weight polyester, in the form of for example chips or pellets obtained from the second step, is subjected to high temperatures and low pressure to effect a further increase in molecular weight and viscosity.

The solid state polymerization step is for example as is taught in U.S. Pat. Nos. 6,160,085 and 7,205,379 and published U.S. app. No. 2005/272906, the contents of which are hereby incorporated by reference.

The SSP step is for example carried out at from about 190 to about 230° C., for example from about 195 to about 225° C. The pressure is for example reduced to from about 0.1 torr to about 50 torr, for instance from about 0.5 torr to about 10 torr. The temperature, pressure and reaction time may be suitably selected so that polyester having the desired physical properties will be formed.

The SSP step may be performed under an inert gas such as nitrogen, argon or carbon dioxide.

The currently used plants use single or multiple vertical cylindrical reactors 10 to 30 meters in height. In those plants the reactor is operated at a temperature of between about 200 and about 230° C. and a polyester granules moving velocity of 1.00 to 2.52 meters per hour. Within these ranges of temperature, bed height, and granule velocity, a most suitable combination of the three variables is chosen to produce product with the desired IV. Said conventional plants are capable of producing polyethylene terephthalate resin with an IV of from about 0.72 to about 0.86 dL/g, or up to 1.2 dL/g depending on the end use, employing a PET prepolymer with an IV of from about 0.55 to about 0.65 dL/g. The conventional plants increase polymer IV from about 0.12 to about 0.25 dL/g.

The SSP rates of titanate catalyzed polyester to achieve a desired molecular weight build up or viscosity increase are significantly enhanced with the presence of phosphinic acid compounds. The polyester pellets, chips or granules obtained after the SSP step exhibit low levels of acetaldehyde formation. They exhibit excellent color, that is high brightness and low yellow color according to the well known L, a, b color parameters.

The polyester pellets, chips or granules are then re-melted and re-extruded or injection molded to form the final articles, that is bottles, filaments, sheets, molded articles and the like. The extrusion and injection molding conditions are conventional. For example, the polyester may be extruded at a temperature in the range of about 240 to about 315° C. There is low aldehyde formation during this subsequent melt processing. The final articles also exhibit excellent color according to the L, a, b color parameters.

One or both of the first two steps is performed in the presence of an organic titanate catalyst. The titanate catalyst is employed at a level of from about 1 to about 1500 ppm by weight titanium, based on the total weight of dicarboxylic acid or dicarboxylic diester and diol. For example, the present titanate catalyst is employed from about 1 to about 1000 ppm titanium or from about 1 to about 500 ppm titanium, based on the total weight of dicarboxylic acid or dicarboxylic diester and diol. For example, the titanate catalyst is employed from about 2 to about 250 ppm by weight titanium, for instance from about 5 to about 300 ppm by weight titanium, based on the weight of diacid or diester plus diol.

The third SSP step is performed in the presence of a phosphinic acid catalyst. The phosphinic acid compound is employed at a level of from about 50 ppm to about 10,000 ppm by weight, based on the weight of dicarboxylic acid or dicarboxylic diester and diol. For example, the present phosphinic acid compound is employed from about 100 ppm to about 5000 ppm by weight or from about 500 ppm to about 2500 ppm by weight, based on the total weight of diacid or diester plus diol.

For example, the phosphinic acid compound is added at a point prior to, at the start of or during the first esterification or transesterification step.

For example, the phosphinic acid compound is added at a point prior to, at the start of or during the second polycondensation step.

For example, the phosphinic acid compound is added at a point towards the end of the polycondensation step.

For example, the phosphinic acid compound is added in some combination of the above points of addition.

In particular, the phosphinic acid compound is added at a point towards the end of the polycondensation step.

“Towards the end of the polycondensation step” is when one or more of the following conditions are satisfied or thereafter and before solidification of the polyester melt:

a) the polyester melt reaches an IV of at least 0.50 dL/g or

b) vacuum applied to the polyester melt, if any, is at least partially released or

c) if the polyester melt is present in a melt phase polymerization process, adding the phosphinic acid compound within a final reactor for making the polyester polymer or between the final reactor and before a cutter for cutting the polyester melt or

d) if the polyester melt is present in a melt phase polymerization process, following at least 85% of the time for polycondensing the polyester melt or

e) the IV of the polyester melt is within 0.10 dL/g of the IV obtained upon solidification or

f) at a point within 20 minutes or less of solidification of the polyester melt.

The titanate catalyst is added at a point prior to, at the start of or during the first esterification or transesterification step.

The titanate catalyst is added at a point prior to, at the start of or during the second polycondensation step.

For example, the titanate catalyst is added in some combination of the above points of addition.

Titanates are for instance alkyl titanates and include acetyl triisopropyl titanate, titanium(IV) isopropoxide, titanium glycolate, titanium(IV) butoxide, hexyleneglycol titanate, tetraisooctyl titanate, titanium tetramethylate, titanium tetrapropylate, titanium(IV) 2-ethylhexoxide, titanium(IV) (triethanolaminato)-isopropoxide or tetraethylhexyltitanate.

The organic titanates are for example of the formula

Ti(OR)₄

where R is a ligand group typically composed of carbon, oxygen, phosphorus, silicon and/or hydrogen. Typically each R ligand group can contain at least one carbon, preferably 3 or more. The presence of a halide, or of other active substituent, in the ligand group generally is avoided since such groups may interfere with catalytic reactions or form undesired by-products, which would contaminate the polymer. While different ligand groups may be present on the same titanium atom, generally they can be identical to facilitate synthesis of the titanate. In some cases, 2 or more R's may be from a common compound chemically bonded together, other than at the titanium (i.e., a multidentate ligand such as triethanolamine, citric acid, glycolic acid, malic acid, succinic acid or ethanediamine). For example, R is a straight or branched chain alkyl of from 1 to 12 carbon atoms.

Organic titanates are commonly prepared by mixing titanium tetrachloride and the selected alcohol precursor in the presence of a base, such as ammonia, to form the tetraalkyl titanate. The alcohol typically is ethanol, n-propanol, isopropanol, n-butanol or isobutanol. Methanol generally is not selected since the resulting tetramethyl titanate is insoluble in the reaction mass, complicating its isolation.

Tetraalkyl titanates thereby produced are recovered by first removing by-product ammonium chloride (e.g., by filtration) and then distilling the tetraalkyl titanate from the reaction mass. This process generally is limited to the production of titanates having C₄ or shorter alkyl groups since the higher temperatures required to distill longer chain titanates (e.g. tetra-2-hexyl titanate) cause some degradation of the titanate. Titanates having longer alkyl groups are conveniently prepared by transesterification of those having alkyl groups up to C₄ with longer chain alcohols. As a practical matter, the selected tetraalkyl titanate generally will have alkyl chains less than C₁₂ since solubility of the titanate tends to decrease, and fabrication cost tends to increase as the number of carbons increases.

Representative commercial organic titanates are for example sold under the trademark TYZOR available from DuPont or VERTEC from Johnson Matthey.

The phosphinate compounds are of the formula

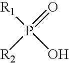

where

R₁ is hydrogen, C₁-C₂₀alkyl, phenyl, C₁-C₄alkyl substituted phenyl, carboxy substituted phenyl, biphenyl, naphthyl, —CH₂—O—C₁-C₂₀alkyl or —CH₂—S—C₁-C₂₀alkyl,

R₂ is C₁-C₂₀alkyl, phenyl, C₁-C₄alkyl substituted phenyl, carboxy substituted phenyl, biphenyl, naphthyl, —CH₂—O—C₁-C₂₀alkyl or —CH₂—S—C₁-C₂₀alkyl, or R₁ and R₂ together are a radical of the formula

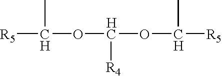

where

R₃, R₄ and R₅ independently of each other are C₁-C₂₀alkyl, phenyl, C₁-C₄alkyl substituted phenyl or carboxy substituted phenyl.

For example R₁ and R₂ are C₄-C₁₂alkyl.

For instance, the phosphinic acid is diisooctyl phosphinic acid (P,P-bis(2,4,4-trimethylpentyl)phosphinic acid).

Other suitable phosphinic acids include methylphosphinic acid, ethylphosphinic acid, propylphosphinic acid, isopropylphosphinic acid, butylphosphinic acid, phenylphosphinic acid, tolylphosphinic acid, xylylphosphinic acid, biphenylphosphinic acid, diphenylphosphinic acid, dimethylphosphinic acid, diethylphosphinic acid, dipropylphosphinic acid, diiospropyphosphinic acid, dibutylphosphinic acid, ditolylphosphinic acid, dixylylphosphinc acid, dibiphenylphosphinic acid, naphthylphosphinic acid, anthrylphosphinic acid, 2-carboxyphenylphosphinic acid, 3-carboxyphenylphosphinic acid, 4-carboxyphenylphosphinic acid, 2,3-dicarboxyphenylphosphinic acid, 2,4-dicarboxyphenylphosphinic acid, 2,5-dicarboxyphenylphosphinic acid, 2,6-dicarboxyphenylphosphinic acid, 3,4-dicarboxyphenylphosphinic acid, 3,5-dicarboxyphenylphosphinc acid, 2,3,4-tricarboxyphenylphosphinic acid, 2,3,5-tricarboxyphenylphosphinic acid, 2,3,6-tricarboxyphenylphosphinic acid, 2,4,5-tricarboxyphenylphosphinic acid, 2,4,6-tricarboxyphenylphosphinic acid, bis(2-carboxyphenyl)phosphinic acid, bis(3-carboxyphenyl)phosphinic acid, bis(4-carboxyphenyl)phosphinic acid, bis(2,3-dicarboxyphenyl)phosphinic acid, bis(2,4-dicarboxyphenyl)phosphinic acid, bis(2,5-dicarboxyphenyl)phosphinic acid, bis(2,6-dicarboxyphenyl)phosphinic acid, bis(3,4-dicarboxyphenyl)phosphinic acid, bis(3,5-dicarboxyphenyl)phosphinic acid, bis(2,3,4-tricarboxyphenyl)phosphinic acid, bis(2,3,5-tricarboxyphenyl)phosphinic acid, bis(2,3,6-tricarboxyphenyl)phosphinic acid, bis(2,4,5-tricarboxyphenyl)phosphinic acid and bis(2,4,6-tricarboxyphenyl)phosphinic acid.

Alkyl is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 2,4,4-trimethylpentyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl.

Alkyl-substituted phenyl, which contains for example 1 to 3, for instance 1 or 2, alkyl groups, is, for example, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl.

### EXAMPLES

The following Examples further illustrate the invention. All parts and percentages are by weight unless otherwise indicated.

### Analytical Procedure:

Intrinsic Viscosity (I.V.): 1 g of polymer is dissolved in 100 g of a 3:2 mixture of phenol and tetrachloroethane. The viscosity of this solution is measured at 35° C. using a Viscotek relative viscometer Y501C and recalculated to the intrinsic viscosity.

### General Polyester (PET) Synthesis Procedure

General polymerization procedure for 4L polycondensation batch reactor. A batch reactor is used which is equipped with a pressurized, heated autoclave reactor with impeller stirrer, inert gas inlet system, a fractionating column to separate water of reaction and ethylene glycol during esterification phase removing water from the reaction and returning ethylene glycol to the reaction mass; a sidearm transfer line connected to collection vessel and vacuum system capable of collecting reaction coproducts ethylene glycol and water during vacuum polycondensation; a discharge valve system at the bottom of the reactor for discharge and isolation of polymer product. Various process points are instrumented with thermocouples and pressure transducers to monitor or control the reaction system.

### Materials

PTA, purified terephthalic acid (8.933 moles, 1484 gms)
PIA, purified isophthalic acid (0.276 moles, 46 grams)
EG, ethylene glycol (11.11 moles, 689 gms)
(optionally) a suppressant to reduce diethylene glycol formation (e.g.) choline hydroxide as a 45% methanolic solution
Titanium catalyst (2% by weight titanium), 300 ppm
Other additives, as desired

The EG (120 mole %) is added and stirring begun. The titanium catalyst is added via pipette and washed in with EG. The DEG (diethylene glycol) suppressant may be added via pipette and washed in with EG. Optionally any liquid additives can be added at this point via pipette. A mixture of 97 mole % PTA with 3% PIA is charged to the reactor. Optionally any solid additives may be added at this point along with the PTA and PIA. Reactor is purged with nitrogen then closed.

For the esterification phase, the reaction mass is conditioned for 20 minutes at a temperature range 93-105° C., stirring at 20 rpm. Heaters are set at 275° C. & sidearm is set to 150° C. Stirring is raised incrementally over 30 minutes, up to 60 rpm when melt temperature reads 200° C. The esterification step is conducted at nominally 50 psig nitrogen pressure and reaches an ultimate temperature of 270° C. The time of esterification begins when water is observed in sight glass of collector (that is, water distills out of fractionating column begins). When the reactor melt temperature reaches nominally 260° C., the heater setpoints are adjusted downward to a final setpoint of about 243° C. which allows a final esterification temperature of about 270° C.

It takes about 1 hour 45 minutes from beginning of the batch (time zero) until the beginning of water distillation from the fractionating column into the water collector. It takes an additional 120 minutes to complete esterification (i.e. when top of column temperature has dropped & stabilized at 125-135° C.).

The next phase of the process sometimes referred to as Atmospheric Esterification (alias pre-polycondensation) occurs when the reactor pressure is released and brought to atmospheric pressure. Atmospheric esterification is conducted for 30 minutes at 270° C. Optionally, additives may be added to the reactor at this point using a septum on the addition port and a large gauge syringe. Addition of additives at this point in the process is considered to be prior to the start of the second step.

The next phase of the process, vacuum polycondensation, occurs when the reactor pressure (i.e. applying a vacuum) is reduced over 60 minutes down to 1 torr or less via programmed vacuum reduction step-down program. Upon reaching final vacuum level, polycondensation continues for about 60 minutes at a final melt temperature target of 285-286° C. Over this total polycondensation time, the reactor stirring speed is reduced in increments as the polymer molecular weight (i.e. melt viscosity) increases. Typically the reactor is held at 60 rpm for 105 minutes, then at 50 rpm for 15 minutes, at 40 rpm for 10 minutes, and at 15 rpm for 15 minutes until polymer discharge. The total time of polycondensation may differ slightly since the reaction endpoint is generally determined by a motor torque value & not by reaction time. Polycondensations of significantly faster reaction rate will reach the endpoint torque value sooner than a standard polyester formulation, such as the case with improved catalysts or coadditives in the formulation. Upon reaching a given motor torque level the polymerization reaction is considered completed. Additives optionally may be added to the reactor at this point using a septum on the addition port and a large gauge syringe. Addition of additives at this point in the process is considered to be towards the end of the second step and prior to the solid state polymerization step. At this time the batch is discharged from the bottom of the reactor, stranded through a water trough and converted to chip. The esterification time is 107 minutes and polycondensation time is 50 minutes. A polyester is produced with dilute solution viscosity value 0.63 dL/g, and carboxylic acid endgroup 34 meq/kg.

### Example 1

A polyester is produced per the general polyester (PET) synthesis procedure. In addition, 0.88 grams of diisooctylphosphinic acid are added to the reactor at the start of the process (start of step 1). The remainder of the polymerization process is conducted as described above. The esterification time is 100 minutes and polycondensation time is 60 minutes. A polyester is produced with dilute solution viscosity value 0.64 dL/g, and carboxylic acid endgroup 23 meq/kg.

### General Solid State Polymerization (SSP) Procedure

The polycondensation in the melt as described in the general polyester (PET) procedure above is followed by a solid state polymerization (SSP) to further increase the molecular weight as measured by monitoring the dilute solution intrinsic viscosity (I.V.).

The following description illustrates the general procedure:

1200 grams of polyethylene terephthalate pellets prepared according to general polyester (PET) procedure, using 300 ppm of titanium catalyst (2 weight % titanium), are placed in a drying oven for 16 hours at 110° C. under a vacuum of 50 torr to dry the pellets. The dried pellets are transferred into a vacuum tumbling dryer. During continuous tumbling of the polyethylene terephthalate under a vacuum of 1 to 2 torr, the temperature is raised to 214° C. over a 2 hour period. After 10 hours at 214° C., the polyethylene terephthalate pellets are cooled. A polyester is produced with dilute solution intrinsic viscosity value (I.V.) 0.71 dL/g.

### Example 2

A polyester is produced by the procedure of Example 1 and 1200 grams of the polyethylene terephthalate pellets are further reacted according to the general solid state polymerization (SSP) procedure at 214° C. over a 10 hour period. A polyester is produced with dilute solution intrinsic viscosity value (I.V.) 0.79 dL/g.

### Example 3

A polyester is produced as per the general polyester (PET) synthesis procedure. In addition, 1.77 grams of diisooctylphosphinic acid are added to the reactor at the start of the process (start step 1). The remainder of the polymerization process is conducted as described above. The esterification time is 93 minutes and polycondensation time is 57 minutes. A polyester is produced with dilute solution viscosity value 0.65 dL/g.

### Example 4

A polyester is produced by the procedure of Example 3 and 1200 grams of the polyethylene terephthalate pellets are further reacted according to the general solid state polymerization (SSP) procedure at 214° C. over a 10 hour period. A polyester is produced with dilute solution intrinsic viscosity value (I.V.) 0.78 dL/g.

### Example 5

A polyester is produced per the general polyester (PET) synthesis procedure. In addition, 0.88 grams of diisooctylphosphinic acid are added to the reactor at the start of the process (start step 1). The remainder of the polymerization process is conducted as described above. The esterification time is 95 minutes and polycondensation time is 40 minutes. A polyester is produced with dilute solution viscosity value 0.59 dL/g.

### Example 6

A polyester is produced by the procedure of Example 5 and 1200 grams of the polyethylene terephthalate pellets are further reacted according to the general solid state polymerization (SSP) procedure at 217° C. over a 10 hour period. A polyester is produced with dilute solution intrinsic viscosity value (I.V.) 0.77 dL/g.

### Example 7

A polyester is produced as per the general polyester (PET) synthesis procedure. In addition, 1.77 grams of diisooctylphosphinic acid are added to the reactor prior to the start of the second step. The remainder of the polymerization process is conducted as described above. The esterification time is 81 minutes and polycondensation time is 58 minutes. A polyester is produced with dilute solution viscosity value 0.64 dL/g.

### Example 8

A polyester is produced as per the general polyester (PET) synthesis procedure. In addition, 1.77 grams of diisooctylphosphinic acid are added to the reactor towards the end of the second step and prior to the solid state polymerization step. The remainder of the polymerization process is conducted as described above. The esterification time is 89 minutes and polycondensation time is 57 minutes. A polyester is produced with dilute solution viscosity value 0.62 dL/g.

### Example 9

A polyester is produced per the general polyester (PET) synthesis procedure with the exception that 150 ppm of titanium catalyst is used instead of 300 ppm of titanium catalyst and 120 ppm of antimony trioxide is added during the addition of the purified terephthalic and isophthalic acids. In addition, 0.88 grams of diisooctylphosphinic acid are added to the reactor at the start of the process (start step 1). The remainder of the polymerization process is conducted as described above. The esterification time is 105 minutes and polycondensation time is 49 minutes. A polyester is produced with dilute solution viscosity value 0.62 dL/g.

### Example 10

A polyester is produced by the procedure of Example 9 and 1200 grams of the polyethylene terephthalate pellets are further reacted according to the general solid state polymerization (SSP) procedure at 218° C. over a 10 hour period. A polyester is produced with dilute solution intrinsic viscosity value (I.V.) 1.23 dL/g.

### Example 11

The SSP procedure is carried out with the polyester of Examples 7 and 8. Excellent results are achieved.

What is claimed is:

1. A method for the preparation of a polyester, which method comprises
in a first step, reacting a dicarboxylic acid or a C₁-C₄ dicarboxylic diester with a diol at a suitable temperature and pressure to effect esterification or transesterification to prepare a precondensate and
in a second step, reacting the precondensate to effect polycondensation at a suitable temperature and pressure to prepare a high molecular weight polyester and
in a third step, further increasing the molecular weight and viscosity of the polyester under solid state polymerization conditions of a suitable temperature and pressure,
where an organic titanate catalyst is added at one or more points
prior to, at the start of or during the first step or
prior to, at the start of or during the second step and
where a phosphinic acid compound is added at one or more points
prior to, at the start of or during the first step,
prior to, at the start of or during the second step or
towards the end of the second step.

2. A method according to claim 1 where the orgainic titanate is of the formula
Ti(OR)₄
where R is a straight or branched chain alkyl of from 1 to 12 carbon atoms.

3. A method according to claim 1 where the organic titanate is acetyl triisopropyl titanate, titanium(IV) isopropoxide, titanium glycolate, titanium(IV) butoxide, hexyleneglycol titanate, tetraisooctyl titanate, titanium tetramethylate, titanium tetrapropylate, titanium(IV) 2-ethylhexoxide, titanium(IV) (triethanolaminato)-isopropoxide or tetraethylhexyltitanate.

4. A method according to claim 1 where the phosphinic acid compound is of the formula 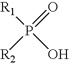
where
R₁ is hydrogen, C₁-C₂₀alkyl, phenyl, C₁-C₄alkyl substituted phenyl, carboxy substituted phenyl, biphenyl, naphthyl, —CH₂—O—C₁-C₂₀alkyl or —CH₂—S—C₁-C₂₀alkyl,
R₂ is C₁-C₂₀alkyl, phenyl, C₁-C₄alkyl substituted phenyl, carboxy substituted phenyl, biphenyl, naphthyl, —CH₂—O—C₁-C₂₀alkyl or —CH₂—S—C₁-C₂₀alkyl, or R₁ and R₂ together are a radical of the formula 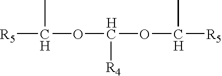
where
R₃, R₄ and R₅ independently of each other are C₁-C₂₀alkyl, phenyl, C₁-C₄alkyl substituted phenyl or carboxy substituted phenyl.

5. A method according to claim 4 where the phosphinic acid is methylphosphinic acid, ethylphosphinic acid, propylphosphinic acid, isopropylphosphinic acid, butylphosphinic acid, phenylphosphinic acid, tolylphosphinic acid, xylylphosphinic acid, biphenylphosphinic acid, diphenylphosphinic acid, dimethylphosphinic acid, diethylphosphinic acid, dipropylphosphinic acid, diiospropyphosphinic acid, dibutylphosphinic acid, ditolylphosphinic acid, dixylylphosphinc acid, dibiphenylphosphinic acid, naphthylphosphinic acid, anthrylphosphinic acid, 2-carboxyphenylphosphinic acid, 3-carboxyphenylphosphinic acid, 4-carboxyphenylphosphinic acid, 2,3-dicarboxyphenylphosphinic acid, 2,4-dicarboxyphenylphosphinic acid, 2,5-dicarboxyphenylphosphinic acid, 2,6-dicarboxyphenylphosphinic acid, 3,4-dicarboxyphenylphosphinic acid, 3,5-dicarboxyphenylphosphinc acid, 2,3,4-tricarboxyphenylphosphinic acid, 2,3,5-tricarboxyphenylphosphinic acid, 2,3,6-tricarboxyphenylphosphinic acid, 2,4,5-tricarboxyphenylphosphinic acid, 2,4,6-tricarboxyphenylphosphinic acid, bis(2-carboxyphenyl)phosphinic acid, bis(3-carboxyphenyl)phosphinic acid, bis(4-carboxyphenyl)phosphinic acid, bis(2,3-dicarboxyphenyl)phosphinic acid, bis(2,4-dicarboxyphenyl)phosphinic acid, bis(2,5-dicarboxyphenyl)phosphinic acid, bis(2,6-dicarboxyphenyl)phosphinic acid, bis(3,4-dicarboxyphenyl)phosphinic acid, bis(3,5-dicarboxyphenyl)phosphinic acid, bis(2,3,4-tricarboxyphenyl)phosphinic acid, bis(2,3,5-tricarboxyphenyl)phosphinic acid, bis(2,3,6-tricarboxyphenyl)phosphinic acid, bis(2,4,5-tricarboxyphenyl)phosphinic acid or bis(2,4,6-tricarboxyphenyl)phosphinic acid.

6. A method according to claim 4 where R₁ and R₂ are C₄-C₁₂alkyl.

7. A method according to claim 4 where the phosphinic acid is diisooctyl phosphinic acid.

8. A method according to claim 1 where a dicarboxylic acid is reacted with a diol to prepare a precondensate and where the dicarboxylic acid is terephthalic acid, isophthalic acid, o-phthalic acid, naphthalene dicarboxylic acid, cyclohexane dicarboxylic acid, cyclohexandediacetic acid, diphenyl-4,4′-dicarboxylic acid, succinic acid, maleic acid, glutaric acid, adipic acid, sebacic acid or a mixture thereof.

9. A method according to claim 1 where a dicarboxylic diester is reacted with a diol to prepare a precondensate and where the dicarboxylic diester is a C₁-C₄ dialkyl diester of terephthalic acid, isophthalic acid, o-phthalic acid, naphthalene dicarboxylic acid, cyclohexane dicarboxylic acid, cyclohexanediacetic acid, diphenyl-4,4′-dicarboxylic acid, succinic acid, maleic acid, glutaric acid, adipic acid, sebacic acid or a mixture thereof.

10. A method according to claim 1 where a dicarboxylic acid is reacted with a diol to prepare a precondensate and where the dicarboxylic acid is terephthalic acid, isophthalic acid or 2,6-naphthalene dicarboxylic acid.

11. A method according to claim 1 where a dicarboxylic diester is reacted with a diol to prepare a precondensate and where the diester is dimethyl terephthalate.

12. A method according to claim 1 where the diol is ethylene glycol, diethylene glycol, triethylene glycol, propane-1,3-diol, propane-1,2-diol, butane-1,4-diol, pentane-1,5-diol, hexane-1,6-diol, 1,4-cyclohexanedimethanol, 3-methylpentane-2,4-diol, 2-methylpentane1,4-diol, 2,2-diethylpropane-1,3-diol, 1,4-di-(hydroxyethoxy)benzene, 2,2-bis(4-hydroxycyclohexyl)-propane, 2,4-dihydroxy-1,1,3,3-tetramethylcyclobutane, 2,2-bis-(3-hydroxyethoxyphenyl)propane, 2,2-bis-(4-hydroxypropoxyphenyl)ethane or a mixtures thereof.

13. A method according to claim 1 where the phosphinic acid is added at one or more points prior to, at the start of or during the first step or prior to, at the start of or during the second step.

14. A method according to claim 1 where the phosphinic acid is added towards the end of the second step.

15. A method according to claim 1 where the organic titanate is present from about 1 ppm to about 1500 ppm by weight titanium, based on the weight of dicarboxylic acid or dicarboxylic diester and diol.

16. A method according to claim 1 where the organic titanate is present from about 2 ppm to about 250 ppm by weight titanium, based on the weight of dicarboxylic acid or dicarboxylic diester and diol.

17. A method according to claim 1 where the organic titanate is present from about 5 ppm to about 300 ppm by weight titanium, based on the weight of dicarboxylic acid or dicarboxylic diester and diol.

18. A method according to claim 1 where the phosphinic acid compound is present from about 50 ppm to about 10,000 ppm by weight, based on the weight of dicarboxylic acid or dicarboxylic diester and diol.

19. A method according to claim 1 where the phosphinic acid compound is present from about 100 ppm to about 5000 ppm by weight, based on the weight of dicarboxylic acid or dicarboxylic diester and diol.

20. A method according to claim 1 where the phosphinic acid compound is present from about 500 ppm to about 2500 ppm by weight, based on the weight of dicarboxylic acid or dicarboxylic diester and diol.
